(19) United States
(12) Patent Application Publication
(10) Pub. No.: US 2005/0098638 A1
(43) Pub. Date: May 12, 2005

(54) Fresh water reclamation system

(76) Inventor: Dan Hanna, Portland, OR (US)

Correspondence Address: Carl D. Crowell, P.O. Box 923, Salem, OR, 97308, US

(21) Appl. No.: 10/704,281

(22) Filed: Nov. 6, 2003

(51) Int. Cl. G05D 23/13

(52) U.S. Cl. 236/12.1

(57) ABSTRACT

A fresh water reclamation system which has diversion means for diverting water flowing from a hot water faucet while waiting for a desired temperature to be reached (warm-up water) to a holding tank for re-use as fresh water.

### FIELD OF THE INVENTION

This invention relates to water reclamation systems, more particularly to an improved water reclamation system for reclaiming water diverted through hot water lines.

### BACKGROUND OF THE INVENTION

Water reclamation is a well-known area and there are many water recycling and re-use systems designed to reclaim, treat and re-use water from various processes. Some examples are car and truck washes, commercial laundry facilities, and other high water consumption processes. These high use facilities, as a result of their huge water use, are exposed to extremely large impact fees. These fees are off-set substantially by the installation of sophisticated re-use or reclamation systems; thereby justifying the cost of installing and maintaining these systems. Unfortunately, these systems are costly and generally cost prohibitive for smaller scale and domestic reclamation applications.

With domestic water availability decreasing and, therefore, costs increasing, there is a need for reclamation in the home. One such domestic water reclamation system is disclosed in U.S. Pat. No. 4,228,006 to Hanna where drain water is reclaimed from non-solids discharge waste water, treated, then re-used for other domestic needs. While this system is effective, it requires various filtering and chemical treatment which is too costly and complicated for the average homeowner.

In most all homes, a large amount of water goes to the sewer unused. The largest source of this water is the water that the user runs through the hot water tap waiting for the water temperature to reach a preferred temperature (hereinafter “warm up water”). Many shower users turn on the shower, perform various preparatory tasks, then several minutes later make their final water adjustment and get in the shower. During this time, many gallons of unused, fresh water go to the sewer. This clean water can be inexpensively reclaimed with no filtering and no added chemical treatment required.

### SUMMARY OF THE INVENTION

The present invention is a water system which has the capability of collecting “warm-up water,” or water that is typically flowing to the sewer while waiting for the hot water to reach a desired temperature.

In the Preferred embodiment, a hot water valve is turned to an on or flow position. Connected to the hot water valve while in the on position is an adjustable thermal switching means that has an adjustable set temperature. The adjustable thermal switching means senses the temperature of the water flowing from the hot water valve and actuates a valve within the thermal switching means to a first position that diverts warm-up water to a holding tank. As soon as the thermal switching means senses the set temperature, the thermal switching means actuates the valve within the thermal switching means to a second position thereby delivering hot water to a hot water demand. The water that is collected in the holding tank is then available as a supply of fresh water.

In an alternate embodiment, the warm-up water is diverted to a holding tank, pressurized and used in tandem with the incoming city or well water.

In another alternate embodiment, the warm-up water diversion valve is a manual valve that is opened and closed manually by the user when the user is ready to use the hot water.

### BRIEF DESCRIPTION OF THE DRAWINGS

The above description and other objects, advantages, and features of the present invention will be more fully understood and appreciated by reference to the specification and accompanying drawings, wherein:

FIG. 1 is a block diagram of the elements of the preferred embodiment of the present invention and of components connected to the system;

FIG. 2 is a representation of the flowchart of the preferred embodiment of the present invention for determining when the warm-up water is ready to be dispensed to the hot water demand; and

FIG. 3 is a block diagram of the elements of an alternate embodiment of the present invention and of components connected to the system.

### DETAILED DISCUSSION OF THE PREFERRED EMBODIMENTS

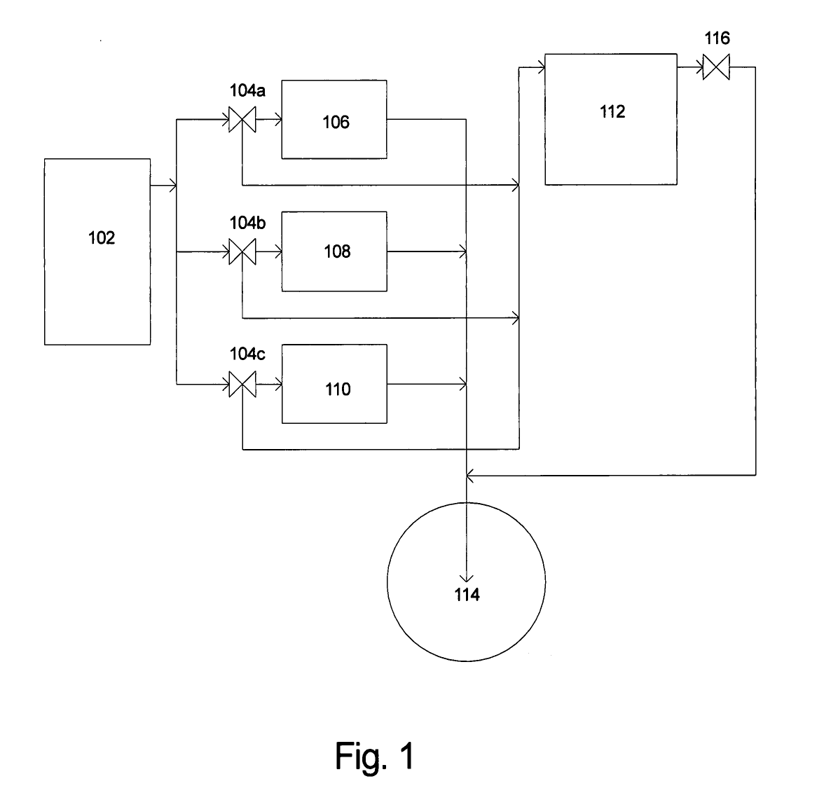

Referring to the figures, like elements retain their indicators throughout the several views. FIG. 1 is a block diagram of the elements of the preferred embodiment of the present invention. Fresh water is delivered to Hot Water Heater 102 from Fresh Water Source 100. Typically, Fresh Water Source 100 is either city water or a domestic well. Hot Water Heater 102 is plumbed to all hot water demands throughout the home providing hot water to wash basins, sinks, bathtubs, and showers. In FIG. 1, Hot Water Valve 103 is the on/off control for Hot Water Demand 106. Hot Water Demand 106 can be a sink, bathtub, or shower. Although only one such sink, bathtub, or shower is depicted, it is common for homes to have multiples of each.

Thermal Switching Means 104 is set to a user's desired minimum temperature. When Hot Water Valve 103 is turned to the “on” position, Thermal Switching Means 104 senses the temperature of the warm-up water at or near Hot Water Demand 106. Until the warm-up water reaches the desired minimum temperature, the warm-up water is diverted to Reclaim Tank 112. As soon as Thermal Switching Means 104 senses the set minimum temperature has been reached, the flow of hot water switches from Reclaim Tank 112 to Hot Water Demand 106 supplying the user with hot water at his sink, bathtub, or shower.

Additionally, when the water begins to pour from the faucet or shower, it serves as both a visual and an audio signal to the user that the water is ready for use, thereby minimizing the water wasted during excessive warm-up time.

Waste water from Hot Water Demand 106 goes to Sewer 1114. In the event Reclaim Tank 112 reaches its full capacity, Reclaim Tank Overflow Valve 116 diverts the overflow from Reclaim Tank 112 to Sewer 114.

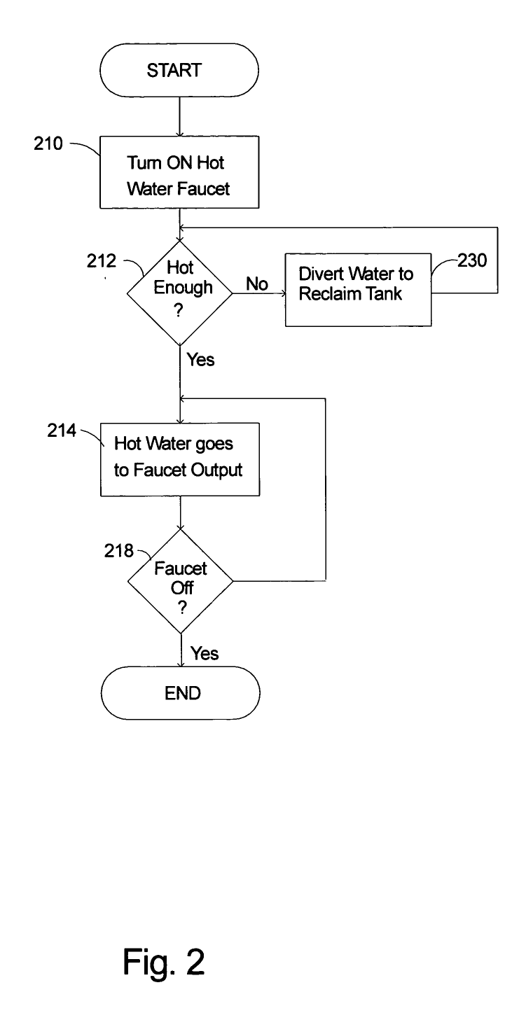

FIG. 2 is a representation of the flowchart of the preferred embodiment of the present invention for determining when to divert water to Reclaim Tank 112 and when it is ready to be dispensed at Hot Water Demand 106. In Block 210 a Hot Water Switch 103 is turned to the “on” position. In Block 230, warm-up water is diverted to Reclaim Tank 112. In Block 212, Thermal Switching Means 104 senses the temperature of the warm-up water. If the warm-up water is not hot enough, control moves back to Block 230 where the warm-up water continues to flow to Reclaim Tank 112. When in Block 212 it is determined that the warm-up water has reached the set minimum temperature, control moves to Block 214 where the warm-up water is diverted from Reclaim Tank 112 to Hot Water Demand 106. Block 218 queries the status of Hot Water Valve 103. If Hot Water Valve 103 is in the on position, control returns to Block 214 where hot water continues to flow to the Hot Water Demand 106. If Hot Water Valve 103 is turned to the off position, the sequence is complete and flow to Hot Water Demand 106 ceases.

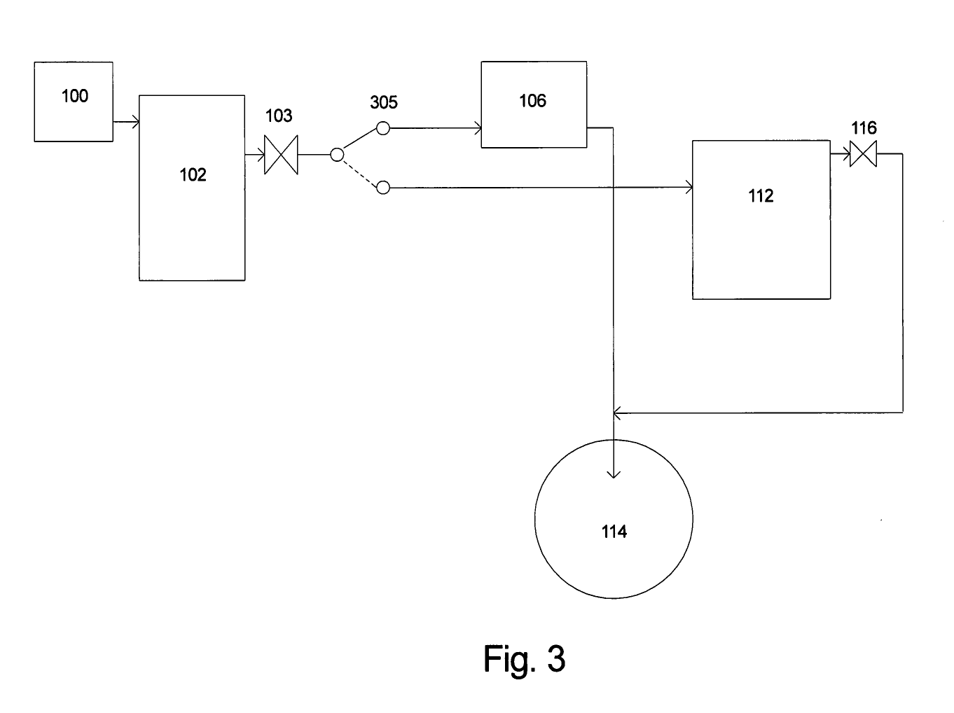

FIG. 3 is a block diagram of the elements of an alternate embodiment of the present invention. Fresh water is delivered to Hot Water Heater 102 from Fresh Water Source 100. Typically, Fresh Water Source 100 is either city water or a domestic well. Hot Water Heater 102 is plumbed to all hot water demands throughout the home providing hot water to wash basins, sinks, bathtubs, and showers. In FIG. 3, Hot Water Valve 103 is the on/off control for Hot Water Demand 106. Hot Water Demand 106 can be a sink, bathtub, or shower. Although only one such sink, bathtub, or shower is depicted, it is common for homes to have multiples of each.

Manual Valve 305 is connected to the outfeed of Hot Water Valve 103 which diverts the heated water to Hot Water Demand 106 when placed in the first position (denoted in FIG. 3 by the solid switch position of Manual Valve 305) or diverts the heated water to Reclaim Tank 112 when placed in the second position (denoted in FIG. 3 by the dashed switch position of Manual Valve 305). In this alternate embodiment, the user has the option of leaving Manual Valve 305 in the divert or second position thereby diverting the unused warm-up water to Reclaim Tank 112 until he is ready to use the hot water at which time he will switch Manual Valve 305 to the first position.

As in the preferred embodiment, waste water from Hot Water Demand 106 goes to Sewer 114. In the event Reclaim Tank 112 reaches its full capacity, Reclaim Tank Overflow Valve 116 diverts the overflow from Reclaim Tank 112 to Sewer 114.

Wherein the terms and expressions which have been employed in the foregoing specification are used therein as terms of description and not of limitation, there is no intention, in the use of such terms and expressions, of excluding equivalents of the features shown and described or portions thereof, it being recognized that the scope of the invention is defined and limited only by the claims which follow.

1. A water reclamation system, the system comprising:
a water supply;
a water demand having a temperature, wherein a set temperature is desired;
a water valve connected to the water supply having an on position, an off position, and an outfeed;
a diversion valve having an infeed connected to the outfeed of the water valve when the water valve is in the on position, the diversion valve having a first position and a second position;
an adjustable thermal sensing means for sensing the temperature of the water at the infeed of the diversion valve and signaling the diversion valve to switch between the first position and the second position; and
a holding tank for holding reclaimed water; whereby the water valve in the on position supplies water to the infeed of the diversion valve, the diversion valve is in the first position thereby diverting water to the holding tank, the adjustable thermal sensing means senses the temperature of the water at the infeed of the diversion valve and when the temperature is equal to the set temperature, adjustable thermal sensing means switches the diversion valve to the second position thereby diverting the water flow to the water demand.

2. The water reclamation system of claim 1, wherein the water supply is a hot water heater.

3. The water reclamation system of claim 1, wherein the water valve is a sink hot water valve.

4. The water reclamation system of claim 1, wherein the water valve is a bathtub hot water valve.

5. The water reclamation system of claim 1, wherein the water valve is a shower hot water valve.

6. A water reclamation system for reclaiming water from a faucet, said system comprising:
a holding tank for holding reclaimed water;
a hot water heater for heating water;
the hot water heater having an inlet and an outlet;
the outlet connected to a hot water valve of the faucet;
the inlet connected to a fresh water supply;
the hot water valve having an on position and an off position;
a diversion valve connected to the hot water valve when the hot water valve is in the on position, the diversion valve having a first position for diverting heated water to the holding tank and a second position for diverting heated water to a hot water demand wherein the hot water demand has a set temperature; and
a thermal sensing means for sensing the set temperature of the heated water at the diversion valve; whereby
the diversion valve is in the first position until the thermal sensing means senses the set temperature thereby switching the diversion valve to the second position.

7. The water reclamation system of claim 6, wherein the hot water valve is a sink hot water valve.

8. The water reclamation system of claim 6, wherein the hot water valve is a bathtub hot water valve.

9. The water reclamation system of claim 6, wherein the hot water valve is a shower hot water valve.

10. A water reclamation system, the system comprising:
a hot water supply;
a water demand having a desired water temperature;
a water valve connected to the hot water supply having an on position, an off position, and an outfeed;
a manual diversion valve having an infeed connected to the outfeed of the water valve when the water valve is in the on position, the manual diversion valve having a first position and a second position; and
a holding tank for holding reclaimed water; whereby the water valve in the on position supplies water to the infeed of the diversion valve, whereby the manual diversion valve in the first position diverts hot water from the hot water supply to the holding tank, and when the desired temperature is reached at the water demand, the manual diversion valve is manually switched to the second position and hot water flows to the hot water demand.

11. A method of reclaiming fresh water, the method comprising:
turning on a hot water faucet; and
diverting the fresh water to a holding tank; and
sensing a temperature of the fresh water going to the holding tank; and
comparing the temperature with a set temperature; and
determining the set temperature has been reached; and
diverting the fresh water to a user hot water demand.
